(19) United States
(12) Patent Application Publication
(10) Pub. No.: US 2004/0186729 A1
(43) Pub. Date: Sep. 23, 2004

(54) Apparatus for and method of inputting Korean vowels

(75) Inventors: Hyun-cheol Park, Suwon-si (KR); Son-hui Kim, Yongin-si (KR); Chang-seog Ko, Hwaseong-gun (KR); Young-sun Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/796,992

(22) Filed: Mar. 11, 2004

(30) Foreign Application Priority Data
Mar. 11, 2003 (KR) 2003-15196
Feb. 18, 2004 (KR) 2004-10821

(51) Int. Cl. G10L 11/00

(52) U.S. Cl. 704/276

(57) ABSTRACT

Provided are an apparatus for and a method of inputting Korean vowels. The apparatus includes a gesture database that stores codes of Korean vowels corresponding to each gesture input by a user on a touch screen; a gesture confirmation unit that searches the gesture database and then selects and outputs corresponding codes of Korean vowels based on gestures that are input by the user on the touch screen. Accordingly, the user can more easily input Korean vowels.

This application claims the priority of Korean Patent Application Nos. 2003-15196 and 2004-10821, filed on Mar. 11, 2003, and Feb. 18, 2004, respectively, in the Korean Intellectual Property Office, the disclosures of which are incorporated herein in their entirety by reference.

### BACKGROUND OF THE INVENTION

1. Field of the Invention

Apparatuses and methods consistent with the present invention relate to inputting Korean language characters, and more particularly, to inputting Korean vowels more conveniently.

2. Description of the Related Art

Information communication terminals such as mobile phones, personal digital assistants (PDAs), and personal computers (PCs) use various methods to input Korean language characters.

For example, a keyboard for a computer has a QWERTY structure. A mobile communication terminal like a PDA has a touch screen as an input medium, and a user inputs characters, numbers, or symbols by tapping keys of a software keyboard displayed on the touch screen with a stylus pen.

A software keyboard for many mobile communication terminals using Korean language characters has a keyboard similar to a QWERTY computer keyboard. However, the user feels uncomfortable using this type of keyboard because a screen is too small for displaying the whole keyboard. Accordingly, some part of the keyboard is first displayed on the screen, and then, the rest of the keyboard is displayed when the user presses a special key. Thus, the user has to press special keys several times to enter a desired text.

A different type of software keyboard for Korean language characters used in a mobile communication terminal, employs a “cheonji-in” keyboard structure (“cheon,” “ji,” and “in” literally mean heaven, earth, and man, respectively).

FIG. 1 is a drawing illustrating an exemplary keyboard structure of the “cheon-ji-in” type. This type of keyboard structure is useful for a mobile phone having a limited number of keyboard keys and a mobile communication terminal having a small touch screen since all Korean vowels can be input using three basic form elements, i.e., “ [symbol] ”, “•”, and “ [symbol] ”.

Yet, the “cheon-ji-in” keyboard structure still has a problem since a user has to press some keys several times in order to input Korean vowels.

The Table 1 below shows the number of pressing operations that have to be performed when inputting Korean vowels using this type of keyboard.

TABLE 1

| | | No. of pressing |
|---|---|---|
| Korean vowel | Key combination | operations |
| [symbol] | [symbol] + · | 2 |
| [symbol] | [symbol] + · + · | 3 |
| [symbol] | [symbol] + · + · + [symbol] | 4 |
| [symbol] | · + · + [symbol] + [symbol] | 4 |
| [symbol] | · + — + [symbol] + · | 4 |
| [symbol] | · + — + [symbol] + · + [symbol] | 5 |

As shown in Table 1, when inputting Korean vowels using the “cheon-ji-in” keyboard, the user has to press the appropriate keys 5 times at the most and usually 4 times in the case of double vowels (diphthongs).

In addition, the three basic form elements, i.e., “ [symbol] ”, “•”, “ [symbol] ”, are arranged in a row on an upper or a lower portion of the “cheon-ji-in” keyboard. Therefore, in order to input a predetermined vowel, a user is required to separate the predetermined vowel into basic form elements, such as “ [symbol] ”, “•”, and “ [symbol] ”, and determine in what order he/she should input the elements using the “cheon-ji-in” keyboard.

### SUMMARY OF THE INVENTION

The present invention provides an apparatus and method for inputting Korean vowels in a more convenient way.

According to an aspect of the present invention, there is provided an apparatus for inputting Korean language characters, the apparatus including: a gesture database that stores codes of Korean vowels corresponding to each gesture input by a user on a touch screen; and a gesture confirmation unit that searches the gesture database, and then, selects and outputs corresponding codes of Korean vowels based on gestures input by the user on the touch screen.

In an exemplary embodiment, the apparatus further includes a touched area confirmation unit that checks whether areas touched by the user are vowels or not, based on touch area signals representing areas on the touch screen touched by the user; a touch confirmation unit that outputs the touch area signals through the gesture confirmation unit if areas touched by the user are vowels, wherein the gesture confirmation unit checks whether touched area signals are gestures or not, searches the gesture database, and then, selects and outputs codes of Korean vowels corresponding to the gestures if the touch area signals are gestures.

In an exemplary embodiment, the gesture confirmation unit determines the touch area signals as gestures if the signals are generated corresponding to stroking actions in predetermined vowel areas displayed on the touch screen.

In an exemplary embodiment, the vowel areas include a downward left-hand stroke area representing a downward left-hand stroke of Korean vowels at the center of the downward left-hand stroke area, first and second horizontal stroke areas representing a horizontal stroke of Korean vowels upside and downside of the downward left-hand stroke area, and first and second vertical stroke areas representing a vertical stroke of Korean vowels at the left and right side of the downward left-hand stroke area.

In an exemplary embodiment, the gesture confirmation unit determines gestures input by the user according to kinds of plural areas that are lined among plural areas consisting of vowel areas, searches the gesture database, and then, selects codes of Korean vowels corresponding to the gestures.

According to another aspect of the present invention, there is provided a method of inputting Korean language characters, the method including: (a) receiving gestures input by a user on a touch screen; (b) deciding Korean vowels corresponding to the gestures; and (c) outputting the Korean vowels determined in the previous step.

In an exemplary embodiment, step (a) further includes: (a1) deciding whether areas touched by the user on the touch screen are vowels or not; and (a2) checking whether touching actions by the user on the touch screen are gestures or not, if the areas touched by the use are vowel areas.

In an exemplary embodiment, step (a2) determines user's actions to be gestures if they are stroking actions in predetermined vowel areas displayed on the touch screen.

In an exemplary embodiment, the vowel areas include a downward left-hand stroke area representing a downward left-hand stroke of Korean vowels at the center of the downward left-hand stroke area, first and second horizontal stroke areas representing a horizontal stroke of Korean vowels upside and downside of the downward left-hand stroke area, and first and second vertical stroke areas representing a vertical stroke of Korean vowels at the left and right side of the downward left-hand stroke area.

In an exemplary embodiment, step (b) determines gestures input by the user according to kinds of plural areas that are lined among plural areas consisting of the vowel areas.

According to still another aspect of the present invention, there is provided an apparatus for inputting Korean vowels. The apparatus includes a Korean language character input unit, which comprises a plurality of keys for inputting Korean vowels. The plurality of keys includes a downward left-hand stroke key, which represents a downward left-hand stroke of Korean vowels; a first horizontal stroke key, which is located above the downward left-hand stroke key and represents a horizontal stroke of Korean vowels; a second horizontal stroke key, which is located below the downward left-hand stroke key and represents the horizontal stroke of Korean vowels; a first vertical key, which is located on the left of the downward left-hand stroke key and represents a vertical stroke of Korean vowels; and a second vertical key, which is located on the right of the downward left-hand stroke key and represents the vertical stroke of Korean vowels.

### BRIEF DESCRIPTION OF THE DRAWINGS

The above and other features and advantages of the present invention will become more apparent by describing in detail exemplary embodiments thereof with reference to the attached drawings in which:

FIG. 1 is a drawing showing an example of keyboard structure of the “cheonji-in” type;

FIG. 2 is a drawing showing an example of a keyboard for inputting Korean vowels according to the present invention;

FIG. 3 is a drawing showing an example of vowel areas for inputting Korean vowels;

FIGS. 4A and 4B are drawings showing an example of inputting Korean vowels using vowel areas according to the present invention;

FIG. 5 is a drawing showing an example of inputting Korean vowels using vowel areas shown in FIG. 3, according to the present invention;

FIG. 6 is a block diagram of an apparatus of inputting Korean vowels according to a first embodiment of the present invention;

FIG. 7 is a flowchart showing a method of inputting Korean vowels according to an exemplary embodiment of the present invention; and

FIG. 8 is a block diagram of an apparatus for inputting Korean vowels according to a second embodiment of the present invention.

### DETAILED DESCRIPTION OF THE INVENTION

The present invention now will be described more fully with reference to the attached drawings, in which exemplary embodiments of the invention are shown.

FIG. 2 is a drawing showing an example of a keyboard for inputting Korean language characters according to the present invention. Referring to FIG. 2, consonant keys are arranged on the left side of the keyboard and vowel keys are on the right side.

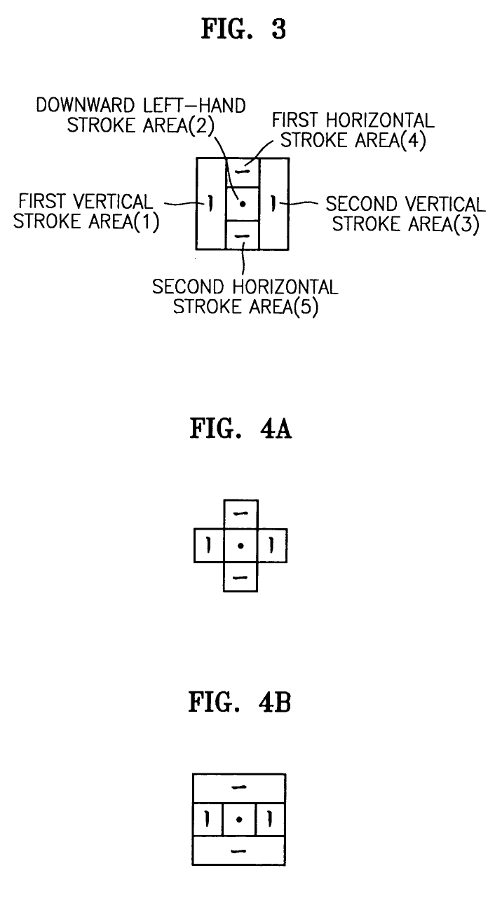

FIG. 3 is a drawing showing an example of vowel areas for inputting Korean vowels.

The present invention employs three basic form elements, i.e., “ [symbol] ”, “•”, and “ [symbol] ” which are used in the conventional “cheon-ji-in” method for inputting Korean vowels.

Referring to FIG. 3, vowel areas of the present invention include a downward left-hand stroke area 2 representing the downward left-hand stroke of Korean vowels, “•” at the center of the vowel areas, first and second horizontal stroke areas 4 and 5 representing a horizontal stroke of Korean vowels, “ [symbol] ” above and below the downward left-hand stroke area 2, and first and second vertical stroke areas 1 and 3 representing a vertical stroke of a Korean vowel, “ [symbol] ” at the left and right sides of the downward left-hand stroke area 2.

FIGS. 4A and 4B are drawings showing another example of inputting Korean vowels based on the vowel areas shown in FIG. 3. Similar to the vowel areas in FIG. 3, a downward left-hand stroke area is disposed at the center, horizontal stroke areas are formed above and below the downward left-hand stroke area and vertical stroke areas are at the left and right sides of the downward left-hand stroke area.

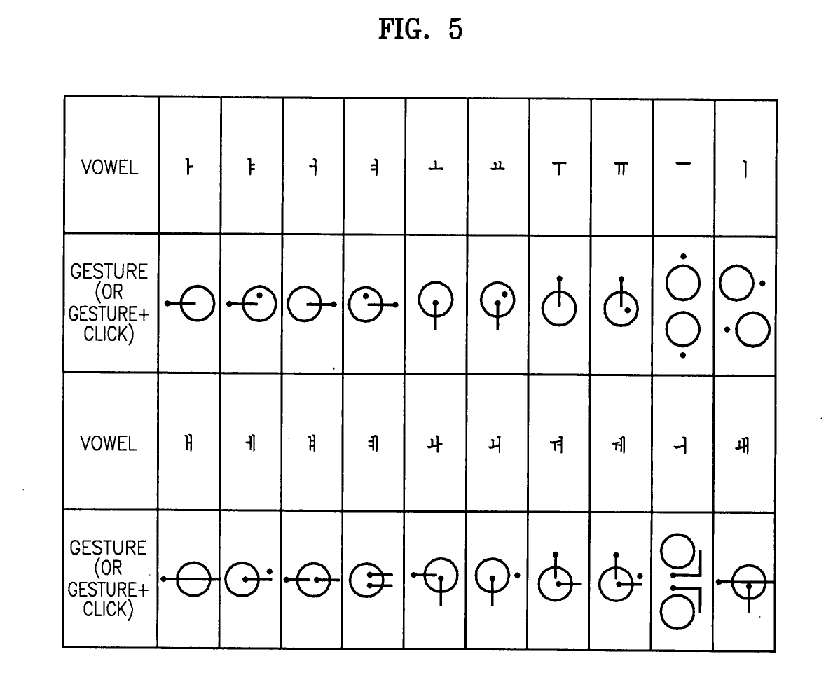

FIG. 5 is a drawing showing an example of inputting Korean vowels using vowel areas shown in FIG. 3 according to the present invention.

As described in FIG. 3, a user inputs vowels by touching vowel areas displayed in a predetermined region on a touch screen using an input medium like a stylus pen (not shown). Similar with the prior art, touching actions are divided into clicking or tapping a displayed area of the relevant key with the stylus pen and stroking, through plural areas of vowels. The latter action is called a “gesture”.

A user can input Korean vowels more conveniently by using the gesture since the touch screen has a smooth surface and the stylus pen easily slides on the touch screen.

Now, a principle of inputting Korean language characters will be explained according to the present invention.

A circle that is illustrated in a line corresponding to a gesture (or gesture+click) in FIG. 5 indicates the downward left-hand stroke area 2 in FIG. 3. Although it is not specifically displayed, first and second horizontal stroke areas 4 and 5 exist above and below the downward left-hand stroke area and first and second vertical stroke areas 1 and 3 at the left and right sides of the downward left-hand stroke area that is the same as FIG. 3. In addition, a segment indicates a gesture, and a dot indicates a click or a tap.

The principle of inputting Korean vowels will be explained using several key vowels.

First, in the case of inputting vowel “ [symbol] ”, the user uses a gesture of stroking from the first vertical stroke area 1 to the downward left-hand stroke area 2 using a stylus pen. In this case, a direction of stroking does not matter. In other words, the apparatus of inputting Korean language characters according to the present invention recognizes the gesture as vowel “ [symbol] ” regardless of a starting direction of stroking, only if the line is drawn between the first vertical stroke and the downward left-hand stroke area. Therefore, vowel “ [symbol] ” can be input by one gesture, in contrast to the conventional “cheon-ji-in” method in which 2 keys have to be pressed.

In the case of vowel “ [symbol] ”, the user inputs vowel “ [symbol] ” by a gesture of stroking from the first vertical stroke area 1 to the downward left-hand stroke area 2 using a stylus pen and clicking the downward left-hand stroke area once. Also in this case, a starting direction of stroking does not matter. According to a general rule, a sequence of a gesture and click is not important; that is, a gesture to input “ [symbol] ” is first used and then the downward left-hand stroke area 2 is clicked in order to input the downward left-hand stroke.

In order to input a single vowel such as “ [symbol] ” and “ [symbol] ”, the user just needs to click a key once in the horizontal stroke areas 4 and 5, and a key once in the vertical stroke areas 1 and 3, respectively. There is no need to make a gesture in this case.

In the case of vowel “ [symbol] ”, the user makes a gesture of stroking from the first vertical stroke area 1 through the downward left-hand stroke area 2 to the second vertical stroke area 3.

As a result, a single corresponding Korean vowel is determined out of plural areas consisting of vowel areas, based on which areas a line or a stroke is drawn through. As displayed in FIG. 5, it is possible that each vowel can be exclusively matched to a corresponding gesture, click, or combination of gesture(s) and click(s).

Likewise, the user can easily input Korean vowels by using a click action and a gesture in vowel areas displayed on the touch screen with a stylus pen.

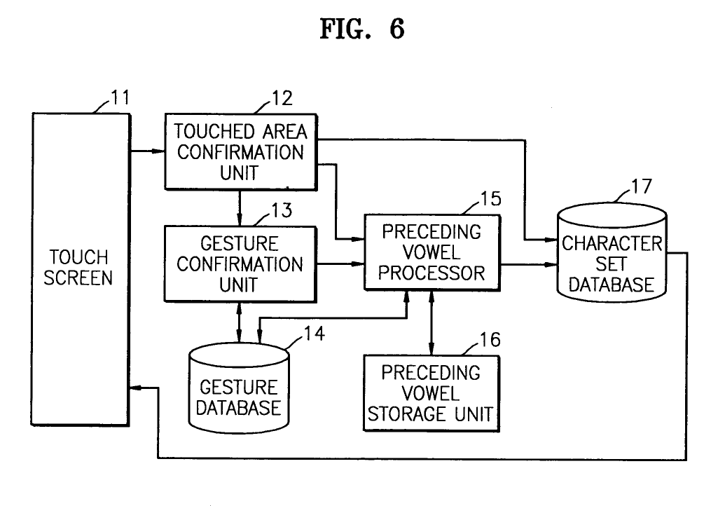

FIG. 6 is a block diagram of an apparatus for inputting Korean vowels according to a first embodiment of the present invention.

Referring to FIG. 6, the apparatus for inputting Korean language characters includes a touch screen 11, a touched area confirmation unit 12, a gesture confirmation unit 13, a gesture database 14, a preceding vowel processor 15, a preceding vowel storage unit 16, and a character set database 17.

As explained above, the touch screen 11 displays Korean vowel areas and outputs signals indicating touched areas of a user (or coordinate signals indicating locations of touched areas of a user) to the touch area confirmation unit 12. In the case of a click action, one coordinate signal is output and in the case of a gesture of stroking in vowel areas, continuous coordinate signals are output.

The touched area confirmation unit 12 receives coordinate signals indicating touched areas of a user from the touch screen 11 and checks whether the touched areas are vowel areas or not. If the touched areas are consonants, numbers, or other keys, the touched area confirmation unit 12 controls the character set database 17 to output the relevant consonants, numbers, or other keys. Also, the touched area confirmation unit 12 controls the preceding vowel processor 15 and removes the pertinent vowel if there is any preceding vowel in the preceding vowel storage unit 16.

The touched area confirmation unit 12 outputs coordinate signals indicating touched areas of a user from the touch screen to the gesture confirmation unit 13, if touched areas are vowel areas.

The gesture confirmation unit 13 receives signals indicating touched areas of a user from the touched area confirmation unit 12 and checks whether the input signals are gesture-indicated ones or not. If received signals are continuous coordinate signals rather than a coordinate signal, the gesture confirmation unit 13 determines that the received signals are gesture-indicated ones.

Once the received signals are checked to be gestures, the gesture confirmation unit 13 searches the gesture database 14, reads Korean vowel codes corresponding to the gestures, and outputs the gestures to the preceding vowel processor 15.

For instance, if continuous coordinate signals from the first vertical stroke area 1 to the downward left-hand stroke area 2 are input, the gesture confirmation unit 13 outputs a relevant Korean vowel code to the preceding vowel processor 15 after checking an input gesture to be vowel “ [symbol] ” based on the gesture database 14 and reading a Korean vowel code indicating vowel “ [symbol] ”.

A coordinate value corresponding to a gesture or a combination of a gesture and click, and each relevant Korean vowel code are stored as a set in the gesture database 14.

If an input signal corresponds to a click action rather than a gesture in the gesture confirmation unit 13, the gesture confirmation unit outputs a relevant Korean vowel code to the preceding vowel processor 15.

The preceding vowel processor 15 checks whether a preceding vowel code exists in the preceding vowel storage unit 16 after receiving a Korean vowel code from the gesture confirmation unit 13. If there is a preceding vowel code in the preceding vowel storage unit 16, a predetermined double vowel made from compounding a preceding vowel code and an input vowel code based on the gesture database 14, is output to the character set database 17. For example, in the case of vowel “ [symbol] ” described in FIG. 5, if the user draws a line from the downward left-hand stroke area 2 to the second vertical stroke area 3, a code corresponding to vowel “ [symbol] ” is stored in the preceding vowel storage unit 16. And then, if the user draws another line from the downward left-hand stroke area 2 to the second vertical stroke area 3, the preceding vowel processor 15 outputs vowel code corresponding to vowel “ [symbol] ” to the character set database 17, based on a code corresponding to vowel “ [symbol] ” stored in the preceding vowel storage unit 16 and the gesture database 14 after receiving a code corresponding to vowel “ [symbol] ” from the gesture confirmation unit 13.

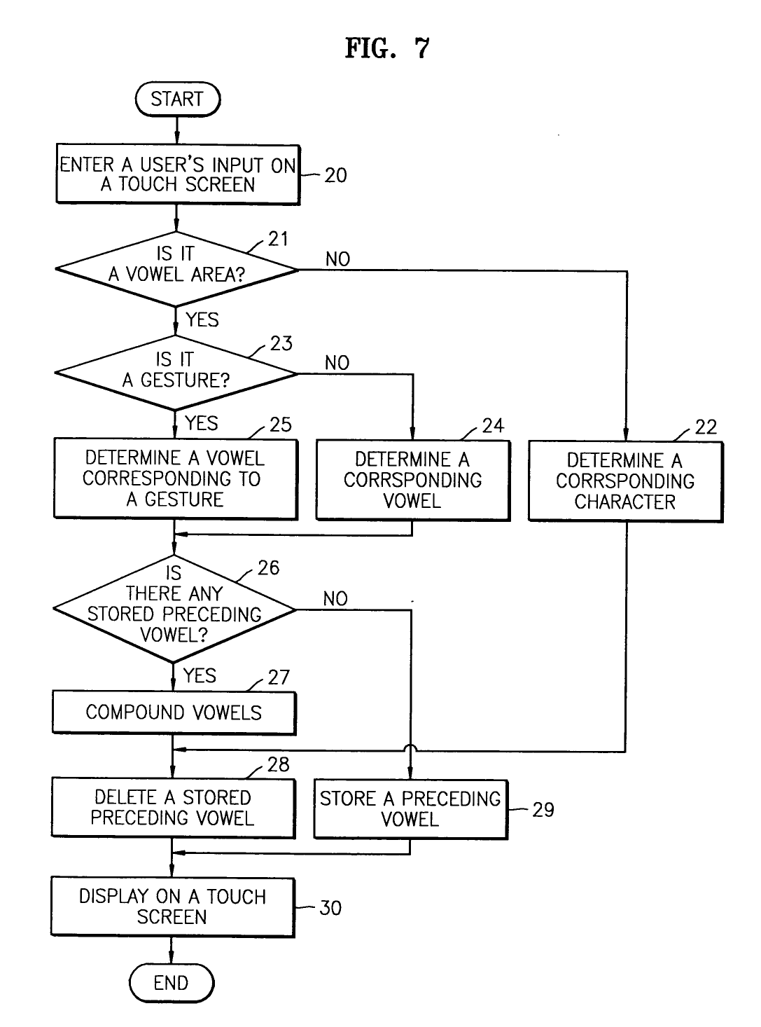

FIG. 7 is a flowchart showing a method of inputting Korea vowels according to an exemplary embodiment of the present invention.

A user inputs a signal by touching predetermined Korean vowel areas displayed on the touch screen in step 20. The touch screen outputs a coordinate signal indicating the touched areas of the user. In the case of a click action, one coordinate signal is output, however in the case of a gesture of stroking through vowel areas, continuous coordinate signals are output.

The touched areas are checked whether they are vowel areas or not in step 21.

If keys for other areas except vowel areas are touched, the relevant consonants or other characters are determined in step 22 and are output on the touch screen in 30 after removing any stored preceding vowel that might exist in step 28.

But, if touched areas of a user are vowel areas, whether signals input by a user are gesture-indicated ones or not are determined in step 23. If input signals are continuous coordinate signals rather than a coordinate signal, the input signals are determined whether they are gesture-indicated ones or not.

In the case that the input signals are a gesture, a Korean vowel corresponding to the input gesture is determined in step 25. For instance, if the input signals are continuous coordinate ones that are from the first vertical stroke area 1 to the downward left-hand stroke 2, the signals are determined to indicate vowel “ [symbol] ”.

However, if the input signal is a click action rather than a gesture, a Korean vowel code corresponding to a clicked area is determined in step 24.

In step 26, whether there is any preceding vowel input for a double vowel or not is determined after determining the Korean vowel input by a user in step 24 or 25.

If there is any preceding vowel, a predetermined double vowel is compounded according to the preceding and input vowels in step 27.

And then, the preceding vowel stored in a predetermined memory, is removed in step 28.

Yet, if there is no preceding vowel, an input vowel is stored in the predetermined memory in step 29. In the case that a next input is a vowel for inputting a double vowel, the input is stored in the predetermined memory. However, if the next input is a consonant, symbol, or number except a vowel, the preceding vowel stored in step 28 is removed.

As a final step, other input vowels are displayed on a predetermined area of the touch screen in step 30.

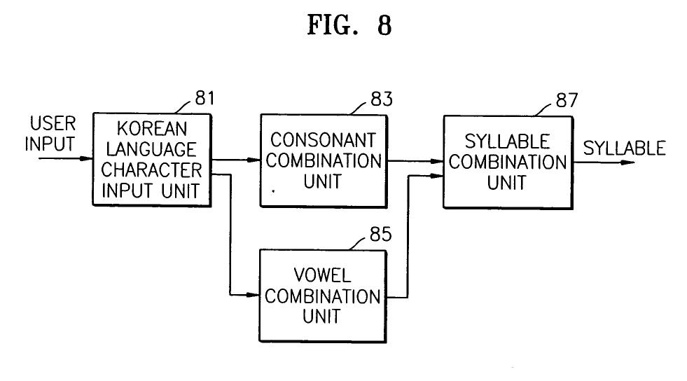

FIG. 8 is a block diagram of an apparatus for inputting Korean vowels according to a second embodiment of the present invention. Referring to FIG. 8, the apparatus includes a Korean language character input unit 81, a consonant combination unit 83, a vowel combination unit 85, and a syllable combination unit 87.

The Korean language character input unit 81 can be realized as a touch screen, on which a plurality of keys for inputting Korean language characters are displayed, or a keypad having the plurality of keys. The Korean language character input unit 81 includes a key structure for inputting Korean vowels, shown in FIGS. 3, 4A or 4B.

The consonant combination unit 83 combines consonants input by a user using the Korean language character input unit 81 and outputs a combination of the input consonants to the syllable combination unit 87. The vowel combination unit 85 combines vowels input by the user using the Korean language character input unit 81 and outputs a combination of the input vowels to the syllable combination unit 87.

The syllable combination unit 87 combines the combination of the input consonants and the combination of the input vowels and outputs resultant Korean syllables.

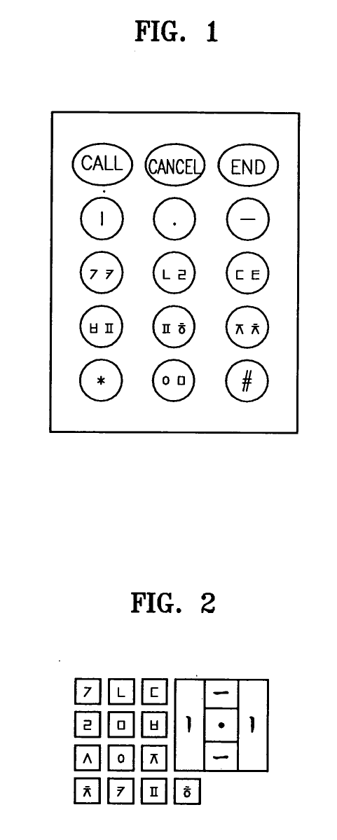

The key structure of FIGS. 3, 4A, or 4B enables the user to more easily and more efficiently input Korean vowels. In the case of the conventional “cheon-ji-in” keyboard of FIG. 1, three basic form elements, i.e., “ [symbol] ”, “•”, “ [symbol] ”, simply are arranged in a row on an upper or lower portion of the “cheon-ji-in” keyboard. Therefore, in order to input a predetermined vowel, a user is required to separate the predetermined vowel into basic form elements, such as “ [symbol] ”, “•”, and “ [symbol] ”, and determine in what order he/she should input the basic form elements using the “cheon-ji-in” keyboard.

The key structure of FIGS. 3, 4A, or 4B includes the downward left-hand stroke area 2, which represents a downward left-hand stroke of Korean vowels, the first and second horizontal stroke areas 4 and 5, which represent horizontal strokes of Korean vowels and are located at upper and lower ends, respectively, of the downward left-hand stroke area 2, and first and second vertical stroke areas 1 and 3, which represent vertical strokes of Korean vowels and are respectively located at either side of the downward left-hand stroke area 2.

In other words, the key structure of FIGS. 3, 4A, or 4B is designed in full consideration of shapes of Korean vowels so that it enables a user to more conveniently input Korean vowels. For example, the user can input a Korean vowel “ [symbol] ” with the use of the conventional “cheon-ji-in” keyboard of FIG. 1 by sequentially hitting a key representing “ [symbol] ”, which is located on the right of a key representing “•”, and the key representing “•”, which is located between the key representing “ [symbol] ” and a key representing “ [symbol] ”. In this case, the user is required to determine in what order he/she should input the basic form elements of the Korean vowel “ [symbol] ”.

However, in the present invention, the user can input the Korean vowel “ [symbol] ” by using the key structure of FIG. 3 to sequentially hit the first horizontal stroke area 4 and the downward left-hand stroke area 2, which are disposed in the Korean language character input unit 81, while envisioning the shape of “ [symbol] ”. Basic form elements of the Korean vowel “ [symbol] ”, input by the user using the Korean language character input unit 81, are input into the vowel combination unit 85. The vowel combination unit 85 combines the basic form elements of the Korean vowel “ [symbol] ” and then outputs “ [symbol] ”. The user can input other Korean vowels in the above-described manner.

As shown in FIG. 6, the apparatus for inputting Korean vowels according to the first embodiment of the present invention allows a user to input Korean vowels by making gestures on the touch screen 11 using a stylus pen. However, the Korean language character input unit 81 of the apparatus for inputting Korean vowels according to the second embodiment of the present invention is not restricted to a touch screen and does not require the user to make gestures to input desired Korean vowels.

The present invention can be realized as computer-readable codes recorded on a computer-readable recording medium. The computer-readable recording medium includes all types of recording devices, such as ROM, RAM, CD-ROM, a magnetic tape, a floppy disk, an optical data storage medium, and a carrier wave (e.g. data transmission through the Internet). The computer-readable recording medium can be distributed over a plurality of computer systems connected to each other in a network so that computer-readable codes can be recorded thereon and read therefrom in a decentralized manner.

As described above, an apparatus for and a method of inputting Korean vowels according to the present invention allow a user to input Korean vowels more conveniently because they provide a key structure, which is designed in full consideration of the shape of Korean vowels so that the user's convenience can be maximized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for inputting Korean vowels, the apparatus comprising:
a gesture database that stores codes of a first set of Korean vowels, wherein the codes of the first set of the Korean vowels correspond to gestures input by a user on a touch screen; and
a gesture confirmation unit that searches the gesture database, and then selects and outputs a corresponding code of a Korean vowel of the first set of Korean vowels based on a gesture input by the user on the touch screen.

2. The apparatus of claim 1, further comprising:
a touched area confirmation unit that checks whether an area touched by the user is a vowel area or not, based on touched area signals representing the area touched by the user on the touch screen, and if the area touched by the user is the vowel area, outputs the touched area signals to the gesture confirmation unit,
wherein the gesture confirmation unit checks whether the touched area signals correspond to the gesture or not, and if the touched area signals correspond to the gesture, searches the gesture database, and then selects and outputs the corresponding code of the Korean vowel of the first set of Korean vowels corresponding to the gesture.

3. The apparatus of claim 1, wherein the gesture confirmation unit determines the touched area signals as corresponding to the gesture if the touched area signals are generated for a stroking action in a vowel area displayed on the touch screen.

4. The apparatus of claim 3, wherein the vowel area comprises a downward left-hand stroke area representing a downward left-hand stroke at a center of the vowel area, a first horizontal stroke area and a second horizontal stroke area representing a horizontal stroke respectively disposed above and below the downward left-hand stroke area, and a first vertical stroke area and a second vertical stroke area representing a vertical stroke respectively at a left side and a right side of the downward left-hand stroke area.

5. The apparatus of claim 4, wherein the gesture confirmation unit determines the gesture input by the user according to kinds of plural areas in the vowel area stroked by the stroking action, searches the gesture database, and then, selects the code of the Korean vowel of the first set corresponding to the gesture.

6. The apparatus of claim 5, wherein the gesture confirmation unit determines the gesture input by the user to correspond to the Korean vowel of the first set of Korean vowels based on rules, wherein the Korean vowel is: a vowel “ [symbol] ” when the gesture represents a line drawn from the first vertical stroke area to the downward left-handed stroke area; a vowel “ [symbol] ” when the gesture represents a line drawn from the downward left-handed stroke area to the second vertical stroke area; a vowel “ [symbol] ” when the gesture represents a line drawn from the downward left-handed stroke area to the second horizontal stroke area; or a vowel “ [symbol] ” when the gesture represents a line drawn from the first horizontal area to the downward left-handed stroke area.

7. The apparatus of claim 5, wherein the gesture confirmation unit determines the gesture input by the user to correspond to the Korean vowel of the first set of Korean vowels based on rules, wherein the Korean vowel is: a vowel “ [symbol] ” when the gesture represents a line drawn from the first vertical stroke area through the downward left-handed stroke area to the second vertical stroke area; and a vowel “ [symbol] ” when the gesture represents a line drawn from the first horizontal stroke area to the second vertical stroke area or a line drawn from the second horizontal stroke area to the second vertical stroke area.

8. The apparatus of claim 6, further comprising:
a preceding vowel storage unit that stores a preceding code corresponding to a Korean vowel previously input by the user; and
a preceding vowel processor that generates double vowel code based on the code of the Korean vowel of the first set or on a code of a Korean vowel of a second set, input from the gesture confirmation unit and the preceding codes that are stored in the preceding vowel storage unit.

9. A method of inputting Korean vowels, the method comprising:
(a) receiving a gesture input by a user on a touch screen;
(b) determining a Korean vowel of a first set of Korean vowels corresponding to the gesture; and
(c) outputting the Korean vowel.

10. The method of claim 9, wherein step (a) further comprises:
(a1) deciding whether an area touched by the user on the touch screen, in a touching action, is a vowel area or not; and
(a2) checking whether the touching action of the user on the touch screen is the gesture or not, if the area touched by the user is the vowel area.

11. The method of claim 10, wherein step (a2) determines the touching action to be the gesture if the touching action is a stroking action in the vowel area displayed on the touch screen.

12. The method of claim 11, wherein the vowel area includes a downward left-hand stroke area representing a downward left-hand stroke at a center of the vowel area, a first horizontal stroke area and a second horizontal stroke area representing a horizontal stroke respectively above and below the downward left-hand stroke area, and a first vertical stroke area and a second vertical stroke area representing a vertical stroke respectively at a left side and a right side of the downward left-hand stroke area.

13. The method of claim 12, wherein step (b) determines the gesture input by the user according to kinds of plural areas in the vowel area stroked by the stroking action.

14. The method of claim 13, wherein step (b) determines the gesture input by the user to correspond to the Korean vowel of the first set of Korean vowels based on rules, wherein the Korean vowel is: a vowel “ [symbol] ” when the gesture represents a line drawn from the first vertical stroke area to the downward left-hand stroke area; a vowel “ [symbol] ” when the gesture represents a line drawn from the downward left-hand stroke area to the second vertical stroke area; a vowel “ [symbol] ” when the gesture represents a line drawn from the downward left-hand stroke area to the second horizontal stroke area; or a vowel “ [symbol] ” when the gesture represents the first horizontal area to the downward left-hand stroke area.

15. The method of claim 13, wherein step (b) determines the gesture input by the user to correspond to the Korean vowel of the first set of Korean vowels based on rules, wherein the Korean vowel is: a vowel “ [symbol] ” when the gesture represents a line drawn from the first vertical stroke area through the downward left-hand stroke area to the second vertical stroke area; a vowel “ [symbol] ” when the gesture represents a line drawn from the first horizontal stroke area to the second vertical stroke area or a line drawn from the second horizontal stroke area to the second vertical stroke.

16. The method of claim 14, further comprising: (d) generating double vowels based on the code of the Korean vowel of the first set of Korean vowels determined at step (c) or a code of a Korean vowel of a second set and a preceding vowel code that was previously stored.

17. A computer readable medium having embodied thereon a computer program for a method of inputting Korean language characters, the method comprising: (a) receiving a gesture input by a user on a touch screen; (b) determining a Korean vowel corresponding to the gesture; and (c) outputting the Korean vowel.

18. An apparatus for inputting Korean vowels, comprising:
a Korean language character input unit, which comprises a plurality of keys for inputting Korean vowels, wherein the plurality of keys comprises:
a downward left-hand stroke key, which represents a downward left-hand stroke of Korean vowels;
a first horizontal stroke key, which is located above the downward left-hand stroke key and represents a horizontal stroke of Korean vowels;
a second horizontal stroke key, which is located below the downward left-hand stroke key and represents the horizontal stroke of Korean vowels;
a first vertical stroke key, which is located leftward of the downward left-hand stroke key and represents a vertical stroke of Korean vowels; and
a second vertical stroke key, which is located rightward of the downward left-hand stroke key and represents the vertical stroke of Korean vowels.

19. The apparatus of claim 18 further comprising a vowel combination unit, which outputs a Korean vowel “ [symbol] ” when a user sequentially hits the first vertical stroke key and the downward left-hand stroke key, a Korean vowel “ [symbol] ” when the user sequentially hits the downward left-hand stroke key and the second vertical stroke key, a Korean vowel “ [symbol] ” when the user sequentially hits the downward left-hand stroke key and the second horizontal stroke key, and a Korean vowel “ [symbol] ” when the user sequentially hits the first horizontal stroke key and the downward left-hand stroke key.

20. The apparatus of claim 18, wherein the Korean language character input unit is a hardware keyboard.

21. The apparatus of claim 18, wherein the Korean language character input unit is a touch screen, and the plurality of keys for inputting Korean vowels are displayed on the touch screen.

22. The apparatus of claim 8, wherein the Korean vowel of the second set of Korean vowels corresponds to a click in the vowel area.

23. The method of claim 16, wherein the Korean vowel of the second set of Korean vowels corresponds to a click in the vowel area.
